(19) United States
(12) Patent Application Publication
(10) Pub. No.: US 2024/0429799 A1
(43) Pub. Date: Dec. 26, 2024

(54) INDUCTIVELY ELECTRICALLY SYNCHRONOUS MACHINE

(71) Applicant: MAHLE International GmbH, Stuttgart (DE)

(72) Inventors: Thorsten Grelle, Stuttgart (DE); Peter Kozlowski, Stuttgart (DE); Penyo Topalov, Stuttgart (DE); Philipp Zimmerschied, Stuttgart (DE)

(21) Appl. No.: 18/708,161

(22) PCT Filed: Oct. 18, 2022
(86) PCT No.: PCT/EP2022/078935

§ 371 Date: May 7, 2024

(30) Foreign Application Priority Data
Nov. 8, 2021 (DE) 10 2021 212 548.4

(51) Int. Cl. H02K 19/12; H01F 38/18; H02K 11/00; H02K 11/049; H02K 11/33

(52) U.S. Cl. CPC H02K 19/12; H01F 38/18; H02K 11/0094; H02K 11/049; H02K 11/33

(57) ABSTRACT

An inductively electrically excited synchronous machine is disclosed. The synchronous machine includes a rotor including at least one rotor coil for generating a magnetic rotor field, a stator including at least one stator coil for generating a magnetic stator field, a rotary transformer including at least one transformer primary coil fixed to the stator and at least one transformer secondary coil arranged fixed to the rotor for supplying the at least one rotor coil with electrical energy. A machine control is connected to the stator coil and the transformer primary coil. A demagnetisation circuit is electrically interconnected with the stator coil and includes a switching device. The switching device is configured so that during a normal operation the switching device deactivates the demagnetisation circuit and that upon a machine fault the switching device activates the demagnetisation circuit.

### CROSS-REFERENCE TO RELATED APPLICATIONS

This application claims priority to International Patent Application No. PCT/EP2022/078935 filed Oct. 18, 2022, which also claims priority to German Patent Application DE 10 2021 212 548.4 filed Nov. 8, 2021, the contents of each of which is hereby incorporated by reference in its entirety.

### TECHNICAL FIELD

The present invention relates to an inductively electrically excited synchronous machine.

### BACKGROUND

A synchronous machine is a rotating electric machine in which during the operation a rotor rotates or runs synchronously with a rotary field of a stator. Generally, a synchronous machine can be operated as a motor or as a generator. In an electrically excited or externally excited synchronous machine, a magnetic field is additionally electrically generated on the rotor. Here, at least one rotor coil is employed, which for generating the rotor-side magnetic field has to be supplied with electrical energy in particular in the form of direct current. In an inductively electrically excited synchronous machine, the supply of the electrical energy to the respective rotor coil takes place in a brushless manner, namely by means of induction. An inductively electrically excited synchronous machine corresponds to a brushless externally excited electric synchronous machine.

A generic synchronous machine is known for example from DE 10 2016 207 392 A1. The generic synchronous machine includes a rotor, which comprises at least one rotor coil for generating a magnetic rotor field. The synchronous machine additionally comprises a stator on which the rotor is rotatably mounted about an axis of rotation and which comprises at least one stator coil for generating a magnetic stator field. Further, the synchronous machine is equipped with a rotary transformer, which comprises at least one transformer primary coil arranged fixed on the stator and at least one transformer secondary coil arranged fixed on the rotor. During the operation of the rotary transformer, the respective transformer secondary coil serves for supplying the respective rotor coil with electrical energy. During the operation of the rotary transformer, the respective transformer primary coil serves for the inductive transmission of electrical energy to the respective transformer secondary coil. For this purpose, a rectifier fixed on the rotor is usually present in addition, which is electrically arranged between the respective transformer secondary coil and the respective rotor coil in order to convert the alternating current of the respective transformer secondary coil into direct current for the respective rotor coil.

Usually, the synchronous machine can be equipped with a machine control which for operating the synchronous machine as motor and/or as generator is connected or coupled to the respective stator coil and to the respective transformer primary coil. Practically, the machine control can be additionally configured so that in case of a machine fault of the synchronous machine it brings about a demagnetisation of the respective rotor coil.

In case of a machine fault, which can occur in one of the components of the synchronous machine, for example within the coils of rotor and stator or within the electronics of the machine control including an inverter, the synchronous machine is switched off or deactivated. This can take place for example by terminating the supply of electrical energy to the respective stator coil and to the respective transformer primary coil. In order to avoid in the process an abrupt blocking of the rotor in the stator or supercritical currents and voltages in the coils, it is required in case of a machine fault to demagnetise the respective rotor coil.

In the known above mentioned DE 10 2016 207 392 A1 it is proposed to provide a braking circuit on the rotor side, which includes a switching element, an activation circuit and a load element. As soon as in case of a machine fault, for example through the deactivation of the stator coils, the rotor-side voltage exceeds a predetermined limit value, the switching element opens and conducts the electrical energy to the load element, in which the electrical energy is converted into heat. In such a rotor-side braking circuit it can be problematic that powerful synchronous machines are exposed to a high thermal load anyway so that the additional heat generated with the load element of the braking circuit cannot be dissipated, so that the electrical components of the braking circuit can easily overheat.

The present invention deals with the problem of showing for an inductively electrically excited synchronous machine an improved or at least another embodiment, in which the demagnetisation of the respective rotor coil in case of a machine fault can be performed rapidly and without overheating.

According to the invention, this problem is solved through the subject of the independent claim(s). Advantageous embodiments are subject of the dependent claims.

### SUMMARY

The invention is based on the general idea of equipping the synchronous machine on the stator side with a demagnetisation circuit, which in the event of a fault can dissipate electrical energy, which is induced by the rotor field on the respective stator coil, so that via the respective stator coil the demagnetisation of the respective rotor coil can take place. With the demagnetisation circuit, the energy can be directly dissipated from the respective stator coil. Thus, an overheating of the rotor and of the stator can thus be avoided.

Practically, this demagnetisation circuit can be controlled internally, for example by means of a control unit or control circuit which monitors a parameter correlating with an undesirable fault case, such as for example a voltage at the stator coil or on a portion of the stator coil and when a predetermined threshold value is exceeded, activates the demagnetisation circuit.

Additionally or alternatively, this demagnetisation circuit can be configured so as to be externally controllable so that it can be specifically activated and deactivated from the outside, preferentially from the machine control. In particular, the demagnetisation circuit in case of a fault can thus be activated synchronously with the deactivation of the synchronous machine. Thus, an extremely short response time is realised. Accordingly, the stator coils that are present anyway are utilised in the invention in order to reduce the magnetic rotor field in case of a fault and dissipate the electrical energy converted in the process.

In detail, the invention proposes to equip the synchronous machine or the machine control with a demagnetisation circuit, which is electrically interconnected with the respective stator coil, which comprises a switching device for activating and deactivating the demagnetisation circuit and at least one consumer of electrical energy and at least one store for electrical energy. Further, the respective switching device is configured and/or controlled in such a manner that during a normal operation of the synchronous machine it deactivates the associated demagnetisation circuit and that upon a machine fault it activates the associated demagnetisation circuit. In the simplest case, the demagnetisation circuit can be designed as braking circuit and comprise the switching device, the consumer and the control unit or the control circuit.

In particular, the switching device can be realised by means of a chopper, which in the process is employed like a brake chopper. The chopper can then be controlled for example dependent on the voltage currently applied to the respective stator coil. For this purpose, a control unit or a corresponding control circuit integrated in the respective switching device which is not shown here, can monitor the respective voltage and control the chopper, preferentially by means of pulse width modulation. As soon as a predetermined voltage threshold value is exceeded, the chopper is controlled for activating the demagnetisation circuit so that the chopper becomes conductive and the consumer or the store can draw current from the respective stator coil. When the monitored voltage again falls below the threshold value, the chopper is controlled for deactivating the demagnetisation circuit, so that the chopper blocks again and the consumer or the store cannot consequently draw any current from the respective stator coil.

Practically, it can now be provided that the respective switching device is configured so that, dependent on a voltage that is tappable at the respective stator coil, it activates the demagnetisation circuit. In the process, one of the tapping points can be arranged between the coil ends and the respective stator coil as a result of which the tapped voltage is only formed by a corresponding part of the coil voltage. In a preferred further development, the respective switching device can be configured so that it activates the demagnetisation circuit when the voltage tapped at the respective stator coil exceeds a predetermined threshold value. This can be particularly easily realised with a power transistor or chopper. Particularly advantageous is a further development, in which the threshold value is selected so that the voltage or coil voltage applied on the respective stator coil remains below a voltage or source voltage, which an electrical energy source provides for supplying the synchronous machine.

Additionally or alternatively, the machine control can be connected or coupled to the respective switching device and configured in such a manner that upon a normal operation of the synchronous machine, it controls the respective switching device for deactivating the demagnetisation circuit while upon a machine fault, it controls the respective switching device for activating the demagnetisation circuit.

Upon a machine fault, the machine control operates for the demagnetisation preferably without stator coil short circuit, so that the stator coils remain active and can be utilised for the inductive dissipating of the rotor field. In connection with the embodiment as braking circuit or braking chopper described above, this means that in case of a fault an inverter need not be short-circuited and is not short-circuited either. Instead, the inverter is merely switched off or opened so that it reflects the vehicle electrical system voltage or battery voltage, in particular as square wave voltage to the respective stator coil. The chopper will then rapidly run up the current and thus reduce the voltage at the respective stator coil or keep the voltage at a low level, preferentially below the level of the vehicle electrical system voltage or battery voltage, and conduct the current away from the battery.

In particular in an embodiment, in which the demagnetisation circuit contains a store, the demagnetisation circuit can additionally contain at least one rectifier, which with activated demagnetisation circuit converts AC voltage applied to the respective stator coil into DC voltage supplying it to the respective consumer or the respective store. Thus, electrical energy induced on the respective stator coil during the demagnetisation of the respective rotor coil can be particularly easily and efficiently dissipated. Such a rectifier is employed in particular when a store is used. Depending on the configuration of the consumer, a rectifier can also be advantageous.

In the usual manner, the machine control can comprise an inverter for supplying electrical energy to the respective stator coil, wherein the inverter can be connected to the respective stator coil via a first inverter line and a second inverter line. The first inverter line is electrically connected to a first coil end of the respective stator coil, while the second inverter line is electrically connected to a second coil end of the respective stator coil. By way of the inverter, the respective stator coil is thus energised for the normal operation of the synchronous machine for generating the stator field. Upon a multi-phase synchronous in machine, multiple stator coils are provided which are practically arranged as star circuit. The first inverter line can then be connected to the respective stator coil on the respective first coil end while the second inverter line is then connected to the so-called star point of the star circuit, which in this case corresponds to the respective second coil end. In this case, the stator coils are each assigned an own first inverter line, while they are assigned a common second inverter line.

In an advantageous further development, the demagnetisation circuit for the electrical interconnection with the respective stator coil can now comprise a circuit line pair with two circuit lines, namely a first circuit line and a second circuit line. The circuit lines can now be utilised for electrically connecting the respective stator coil to the demagnetisation circuit.

According to an advantageous embodiment it can now be provided that the first circuit line is electrically connected to the first inverter line, in particular to the first coil end, while the second circuit line is electrically connected to the second inverter line, in particular to the second coil end. As a consequence, the demagnetisation circuit is connected parallel to the respective stator coil. This simplifies the integration of the demagnetisation circuit in the stator.

In an alternative embodiment, the first circuit line can be electrically connected to the first inverter line, in particular to the first coil end, while the second circuit line is electrically connected to a coil tap of the respective stator coil, which is electrically arranged between the first coil end and the second coil end of the said stator coil. Thus, the demagnetisation circuit does not utilise the entire stator coil but only a part thereof. As a consequence, the voltage, which is tapped by the demagnetisation circuit at the respective stator coil in case of a fault, is then also reduced on a pro-rata basis. Thus, the demagnetisation circuit can be realised with comparatively cost-effective components. With an internally controlled demagnetisation circuit, it can also be achieved through a corresponding control circuit that the switching device is activated even at a comparatively low threshold value for the voltage, so that the demagnetisation becomes active comparatively early.

Practical is a further development, in which the coil tap is arranged within the respective stator coil off-centre between the first coil end and the second coil end. In particular, the coil tap can be arranged within the respective stator coil nearer to the first coil end than to the second coil end. As a consequence, the voltage between the circuit lines or between the coil tap and the second coil end is lower than half the voltage between the two inverter lines or between the two coil ends.

In an advantageous embodiment, the synchronous machine can have a multi-phase preferentially three-phase configuration, wherein each phase is assigned at least one stator coil. Accordingly, the demagnetisation circuit is then electrically interconnected with multiple, preferentially with all stator coils in order to be able to dissipate a lot of energy as quickly as possible in case of a fault.

Another embodiment proposes that the synchronous machine is of a single-phase or multi-phase configuration, wherein each phase is assigned a coil group of multiple stator coils. Provided that such a coil group comprises exactly two stator coils, the coil group can form a coil pair, in which the two associated stator coils are preferentially located diametrically opposite one another. Thus, multiple stator coils are also present here. In this case, the demagnetisation circuit is also electrically interconnected with multiple, preferentially with all stator coils in order to be able to dissipate the energy efficiently and as quickly as possible in case of a fault.

The two above variants can also be combined with one another, so that the synchronous machine is of a multi-phase, preferentially three-phase configuration, wherein each phase is assigned at least one coil pair of two stator coils located diametrically opposite one another. In a three-phase synchronous machine, at least six stator coils are then provided. Here, the demagnetisation circuit is also electrically connected to multiple, preferentially to all stator coils.

Preferably, the respective consumer or the respective store are arranged outside on the stator or outside of the stator, by way of which an overheating of the rotor can be effectively avoided.

The respective consumer can comprise at least one thermoelectric element, which converts electrical energy into heat. For example, this can be a load element, which can be an electrical resistor, a suppressor diode or a Zener diode.

The synchronous machine considered here can preferably be designed as drive motor or traction motor for a motor vehicle and/or for a power of 100 kW to 200 kW, preferentially of 120 kW to 160 kW, in particular of approximately 140 kW.

Further important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention. Parts mentioned above and still to be named in the following of a higher unit, such as for example of an installation, a device or an arrangement which are designated separately can form separate parts or components of this unit or be integral regions or portions of this unit, even when this is shown otherwise in the drawings.

Preferred exemplary embodiments of the invention are shown in the drawings and are explained in more detail in the following description, wherein same reference numbers relate to same or similar or functionally same components.

### BRIEF DESCRIPTION OF THE DRAWINGS

It shows, in each case schematically,

FIG. 1: a highly simplified schematic representation in the form of a circuit diagram of an inductively electrically excited synchronous machine in a first embodiment,

FIG. 2: a highly simplified schematic representation in the form of a circuit diagram of the inductively electrically excited synchronous machine in a second embodiment.

### DETAILED DESCRIPTION

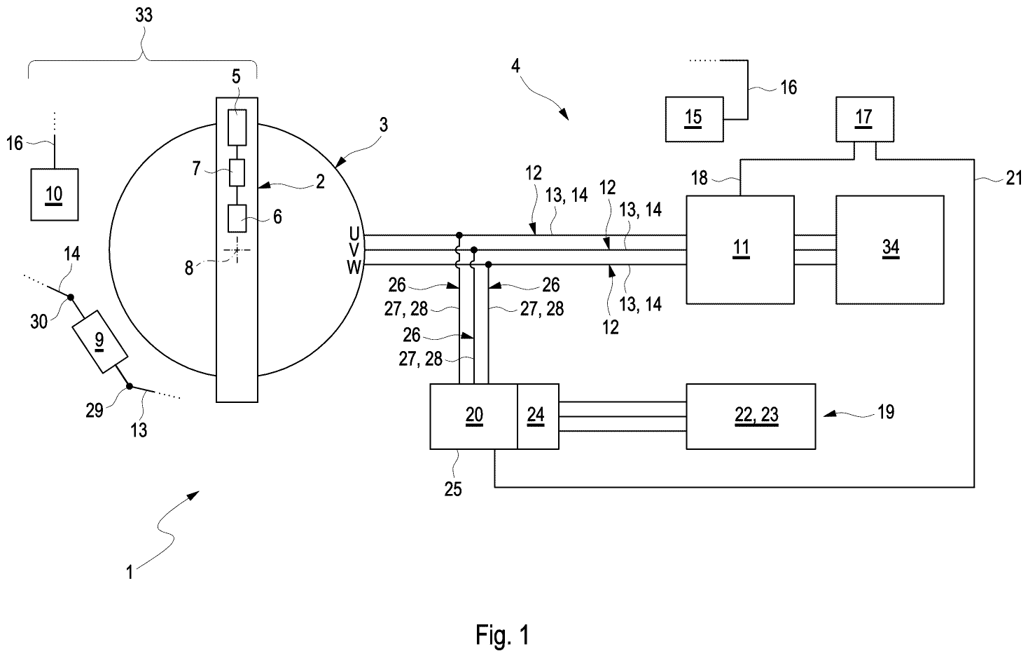

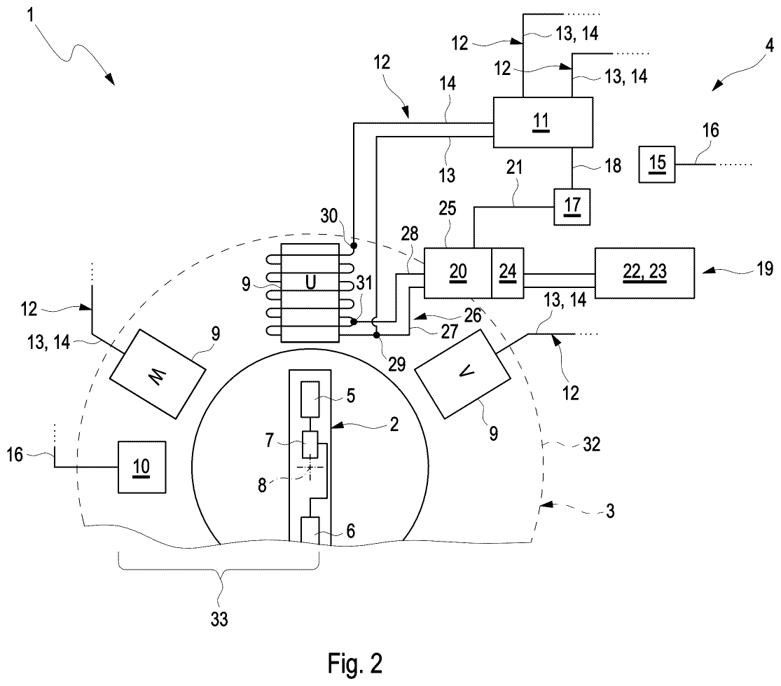

According to the FIGS. 1 and 2, an inductively electrically excited synchronous machine 1 includes a rotor 2, a stator 3 and a machine control 4. The rotor 2 comprises at least one rotor coil 5 for generating a magnetic rotor field and at least one transformer secondary coil 6 for supplying the respective rotor coil 5 with electrical energy. Practically, the rotor 2 can additionally comprise a rectifier 7, which transforms AC voltage supplied by the transformer secondary coil 6 into DC voltage and supplies the same to the rotor coil 5. The rotor 2 is rotatably mounted about an axis of rotation 8 on the stator 3. The stator 3 comprises at least one stator coil 9 for generating a magnetic stator field and a transformer primary coil 10 for the inductive transmission of electrical energy to the respective transformer secondary coil 6. The respective transformer primary coil 10 and the respective transformer secondary coil 6 form a rotary transformer 33, which during the operation transmits electrical energy inductively between the transformer coils 6, 10. With respect to the rotary transformer 33, the representations of the FIGS. 1 and 2 should be understood only schematically. In particular, the transformer coils 6, 10 in a concrete rotary transformer or in a concrete synchronous machine 1 are located axially opposite one another with respect to the axis of rotation 8.

For operating the synchronous machine 1 as motor and/or as generator, the machine control 4 is connected to the respective stator coil 9 and to the respective transformer primary coil 10. For this purpose, the machine control 4 can comprise at least one inverter 11, which, via a first inverter line 13 and a second inverter line 14, is connected to the respective stator coil 9. In the FIGS. 1 and 2, the inverter lines 13 and 14 are shown, simplified, as inverter line pair 12. It is clear that in a multi-phase synchronous machine 1 a star circuit is usually employed. For energising the respective transformer primary coil 10, the machine control 4 can comprise a transformer control 15 which, via corresponding transformer lines 16, is connected to the respective transformer primary coil 10. The transformer control 15 can be in particular integrated in the inverter 11. In addition, the machine control 4 can comprise a control device 17 which can contain at least one CPU and which is connected to the inverter 11 via control line 18. The control device 17 can likewise be structurally integrated in the inverter 11.

Although in FIGS. 1 and 2 only one or three stator coils 9 are shown respectively it is clear that the stator 3 can also comprise more than one or three stator coils 9.

The inverter 11 can be connected to an electrical energy source 34, such as for example a battery or a vehicle electrical system. In FIG. 2, the energy source 34 has been omitted for simplification. The energy source 34 preferably provides DC voltage with a predetermined voltage or source voltage.

The machine control 4 or its control device 17, can now be configured so that it monitors the synchronous machine 1 with respect in particular to predetermined machine faults, such as for example excessive values for temperature, rotational speed, voltage and/or current. As soon as a machine fault is identified, the machine control 4 terminates the supply of electrical energy to the respective stator coil 9 and/or to the respective transformer primary coil 10. Here, this is practically achieved in that the inverter 11 is switched off or deactivated, i.e. is no longer actively controlled. While the active inverter 11 operates as converter, which converts DC voltage coming from the energy source 34 into AC voltage and supplies the same to the respective stator coil 9, the inactive inverter 11 operates as rectifier, which converts the AC voltage coming from the respective stator coil 9 into DC voltage and supplies the same to the energy source 34. Preferentially, a short-circuiting of the respective stator coil 9 should not be brought about in the process. In other words, the machine control 4 preferably operates without stator coil short circuit.

Further, the machine control 4 or its control device 17 can be configured so that in case of a fault it specifically brings about a demagnetisation of the respective rotor coil 5.

For demagnetising the rotor coil 5, the synchronous machine 1 or its machine control 4 is equipped with a demagnetisation circuit 19, which is electrically interconnected with the respective stator coil 9. In the case of multiple stator coils 9, the demagnetisation circuit 19 is practically electrically interconnected to multiple, preferentially to all stator coils 9. The demagnetisation circuit 19 comprises a switching device 20 which is configured so that it can be used to activate and deactivate the demagnetisation circuit 19. The switching device 20 can be configured so that it is internally controlled and operates quasi-independently. This can take place for example through a corresponding control circuit or control unit which is not shown here. For example, the voltage applied to the respective stator coil 9 can be monitored. For externally controlling or for actuating the switching device 20, the machine control 4 or its control device 17 can be connected to this switching device 20 via a corresponding control line 21. The demagnetisation circuit 19 is additionally equipped with at least one consumer 22 of electrical energy and/or with at least one store 23 for electrical energy. Provided that multiple stator coils 9 are present and the demagnetisation circuit 19 is interconnected with multiple or with all stator coils 9, the demagnetisation circuit 19 can comprise a common switching device 20 and at least one common consumer 22 or at least one common store 23, which is assigned to all stator coils 9 with which the demagnetisation circuit 19 is interconnected. The switching device 20 is preferably an electronic switch which can be realised for example by means of diode, transistor, MOSFET, IGBT or chopper. In particular, the switching device 20 can be realised by means of a chopper interconnected as braking chopper, which is controlled for example depending on the voltage currently applied to the respective stator coil 9. For this purpose, a control circuit or a control unit integrated in the respective control device 20 which is not shown here can monitor the respective voltage and control the chopper, preferentially by means of pulse width modulation. As soon as a predetermined voltage threshold value is exceeded, the chopper is controlled for activating the demagnetisation circuit 19, so that the chopper becomes conductive and the consumer 22 or the store 23 can draw current from the respective stator coil 9. When the monitored voltage again falls below the threshold value, the chopper is controlled for deactivating the demagnetisation circuit 19, so that the chopper again blocks and the consumer 22 or the store 23 cannot consequently draw any current from the respective stator coil 9.

In addition, the motor control 4 can be optionally designed so that during a normal operation of the synchronous machine 1 it controls the switching device 20 for deactivating the demagnetisation circuit 19. However, as soon as there is a machine fault, the machine control 4 controls the switching device 20 for activating the demagnetisation circuit 19. When the current supply to the stator coils 19 and to the respective transformer primary coil 10 is switched off, a residual stator field is still present. In addition, the rotor field is still present. Thus, electrical energy is induced in the stator coils 9. Electrical energy can now dissipated via the demagnetisation circuit 19 and consumed in the respective consumer 22 or stored in the respective store 23. By connecting the demagnetisation circuit 19 to the respective stator coil 9, the same can be utilised for decoupling the magnetic rotor field, as a result of which the equipment expenditure for realising the demagnetisation circuit 19 is comparatively low. It is noteworthy that in the process the demagnetisation circuit 19 is located on the stator side, i.e. outside the rotor 2. The energy dissipated during the demagnetisation of the respective rotor coil 5 cannot thus serve for heating up the rotor 2. It is additionally noteworthy that by controlling the switching device 20 via the machine control 4 the rotor field can be reduced in case of a fault before the same can induce an excessive voltage in the stator coil 9.

At least in the event that the demagnetisation circuit 19 contains a store 23, the demagnetisation circuit 19 comprises a rectifier 24, which in the representations of the FIGS. 1 and 2 is formed jointly with the switching device 20 in an assembly 25. However, the rectifier 24 can also be configured separately. With activated demagnetisation circuit 19, the rectifier 24 converts the AC voltage applied to the respective stator coil 9 into DC voltage which is then supplied to the respective consumer 22 or the respective store 23.

The inverter 11 is connected to the stator coils 9 via the inverter lines 13, 14. For the electrical coupling of the inverter 11 to the respective stator coil 9, the first inverter line 13 is electrically connected to a first coil end 29 of the respective stator coil 9 while the second inverter line 14 is electrically connected to a second coil end 30 of the respective stator coil 9. For the electrical interconnection with the respective stator coil 9, the demagnetisation circuit 19 comprises a circuit line pair 26 each, which comprises two circuit lines, namely a first circuit line 27 and a second circuit line 28.

In the first embodiment shown in FIG. 1, the respective first circuit line 27 is electrically connected to the first inverter line 13, while the second line 28 is electrically connected to the second inverter line 14. Thus, a circuit line pair 26 is electrically connected to the inverter lines 13, 14 so that the demagnetisation circuit 19 is connected parallel to the respective stator coil 9. In this case, the electrical energy induced in the respective stator coil 9 when the synchronous machine 1 is switched off is dissipated with the full electrical voltage via the demagnetisation circuit 19.

In the second embodiment shown in FIG. 2 it is provided, by contrast, to electrically connect the first circuit line 27 to the first inverter line 13, for example via the first coil end 29. In contrast with this, the second circuit line 28 in this second embodiment is electrically connected to a coil tap 31, which is additionally present on the respective stator coil 9 and is arranged between the first coil end 29 and the second coil end 30. Thus it is achieved that when the synchronous machine 1 is switched off, the electrical energy induced on the respective stator coil 9 need not be dissipated with the full voltage via the demagnetisation circuit 19, but with a pro-rata voltage which depends on the positioning of the coil tap 31. This can be an advantage in particular with the automatically operating switching device 20 when the same monitors the voltage at the connection or tapping points 29, 31 of the circuit lines 27, 28. In this case, the voltage threshold value, from which the switching device 20 activates the demagnetisation circuit 19, can be selected comparatively low. Thus, it can be achieved in particular that the voltage induced on the respective stator coil 9 remains below a source voltage which is provided by the energy source 34.

In the example of FIG. 2, the coil tap 31 is arranged off-centre between the two coil ends 29, 30. “Off-centre” is to be understood in the electrical sense and refers to the number of the windings within the stator coil 9. There, a configuration is preferred in which the coil tap 31 is located within the stator coil 9 nearer to the first coil end 29 than to the second coil end 30. Accordingly, the stator coil 9 has fewer windings between the first coil end 29 and the coil tap 31 than between the coil tap 31 and the second coil end 30. Thus, the electrical voltage that is tappable via the circuit lines 27, 28 is lower than half the electrical voltage applied to the coil ends 29, 30.

In the shown examples, the synchronous machine 1 has a multi-phase, namely three-phase configuration. The individual phases are designated in the FIGS. 1 and 2 by U, V and W. Each phase U, V, W is assigned at least one stator coil 9. In the present case, each phase U, V, W is assigned a coil pair each, which comprises two stator coils 9, which are located diametrically opposite one another. In FIG. 1, only a single stator coil 9, representative of all stator coils 9, is schematically indicated. In FIG. 2, only one stator coil 9 each of the three coil pairs is indicated, representative of each phase U, V, W, in FIG. 2.

Provided that the stator 3 comprises multiple stator coils 9, the demagnetisation circuit 19 is practically connected to multiple, preferentially to all stator coils 9, wherein this can take place in particular optionally according to the embodiment shown in FIG. 1 or according to the embodiment shown in FIG. 2.

Practically, the respective consumer 22 or the respective store 23 can be arranged outside on the stator 3 or outside of the stator 3. In FIG. 2, a stator housing 32 is indicated with dashed line. The respective consumer 22 or the respective store 23 can be arranged outside on this stator housing 32. In the event that the respective consumer 22 comprises at least one thermoelectrical element, the energy dissipated during the demagnetisation of the respective rotor coil 5 is converted into heat outside the rotor, as a result of which an overheating of the rotor 2 can be avoided.

In the event that an inverter 11 and an energy source 34, in particular battery or vehicle electrical system, are present, it is not required in case of a fault to short-circuit the inverter 11. It can rather be switched off or opened. The voltage reflected or coming back from the respective stator coil 9 is then passed on as square-wave voltage to the energy source 34 by the inverter 11. The demagnetisation circuit 19 activated in case of a fault conducts the current away from the respective stator coil 9 to the consumer 22 or to the store 23. Provided that the switching device 20, as described for example further up, is controlled dependent on a voltage, the voltage threshold value can be specifically selected so that the voltage at the respective stator coil 9 is always below a predetermined limit value. Preferentially, this limit value can be lower than a voltage of the energy source 34, which is provided by the energy source 34. Thus, an efficient protection of the energy source 34, in particular of the battery or of the vehicle electrical system can be achieved.

1. An inductively electrically excited synchronous machine, comprising:
a rotor including at least one rotor coil for generating a magnetic rotor field,
a stator on which the rotor is rotatably mounted about an axis of rotation, the stator including at least one stator coil for generating a magnetic stator field,
a rotary transformer including at least one transformer primary coil fixed to the stator and at least one transformer secondary coil arranged fixed to the rotor for supplying the at least one rotor coil with electrical energy,
a machine control which for operation as a motor and/or as a generator is connected to the at least one stator coil and to the at least one transformer primary coil,
at least one demagnetisation circuit electrically interconnected with the at least one stator coil, the at least one demagnetization circuit including a switching device for activating and deactivating the at least one demagnetisation circuit and at least one consumer of electrical energy and/or at least one store for electrical energy,
wherein the switching device is configured and/or controlled so that during a normal operation the switching device deactivates the at least one demagnetisation circuit and that upon a machine fault the switching device activates the at least one demagnetisation circuit.

2. The synchronous machine according to claim 1, wherein the switching device is configured as a braking circuit or a brake chopper.

3. The synchronous machine according to claim 1, wherein the switching device is configured so that, depending on a voltage that is tappable at the at least one stator coil, the switching device activates the at least one demagnetisation circuit.

4. The synchronous machine according to claim 3, wherein the switching device is configured to activate the at least one demagnetisation circuit when the voltage tapped at the at least one stator coil exceeds a predetermined threshold value.

5. The synchronous machine according to claim 4, wherein the threshold value is selected so that the voltage applied to the at least one stator coil remains below a voltage provided by an electrical energy source.

6. The synchronous machine according to claim 1, wherein the motor control is configured so that during the normal operation, the motor control controls the switching device for deactivating the at least one demagnetisation circuit and that in case of a machine fault the motor control controls the switching device for activating the at least one demagnetisation circuit.

7. The synchronous machine according to claim 1, wherein the at least one demagnetisation circuit contains at least one rectifier, which with the at least one demagnetisation circuit activated converts the AC voltage applied to the at least one stator coil into DC voltage and supplies the DC voltage to the at least one consumer and/or the at least one store.

8. The synchronous machine according to claim 1, wherein:
the machine control includes an inverter for supplying electrical energy to the at least one stator coil, the inverter connected to the at least one stator coil via a first inverter line and a second inverter line for transmitting electrical energy,
the first inverter line is electrically connected to a first coil end of the at least one stator coil, and the second inverter line is electrically connected to a second coil end of the at least one stator coil, and
the at least one demagnetisation circuit for the electrical interconnection with the at least one stator coil includes a circuit line pair with a first circuit line and a second circuit line.

9. The synchronous machine according to claim 8, wherein the first circuit line is electrically connected to the first inverter line and the second circuit line is electrically connected to the second inverter line.

10. The synchronous machine according to claim 8, wherein the first circuit line is electrically connected to the first inverter line, and the second circuit line is electrically connected to a coil tap of the at least one stator coil, the coil tap arranged between the first coil end and the second coil end.

11. The synchronous machine according to claim 10, wherein the coil tap is arranged within the at least one stator coil off-centre between the first coil end and the second coil end.

12. The synchronous machine according to claim 10, wherein the coil tap is arranged within the respective stator coil nearer to the first coil end than to the second coil end.

13. The synchronous machine according to claim 1, wherein the synchronous machine has a multi-phase configuration, wherein each phase is assigned at least one stator coil.

14. The synchronous machine according to claim 1, wherein the synchronous machine has a single-phase or multi-phase configuration wherein each phase is assigned a coil group of multiple stator coils or is assigned at least one coil pair of two stator coils located diametrically opposite one another.

15. The synchronous machine according to claim 1, wherein the at least one consumer and/or the at least one store is/are arranged outside on the stator or outside of the stator.

16. The synchronous machine according to claim 1, wherein the at least one consumer comprises at least one thermoelectrical element which converts the electrical energy into heat.

17. The synchronous machine according to claim 1, wherein the motor control upon a machine fault terminates the supply of electrical energy to the at least one stator coil and/or to the at least one transformer primary coil.

18. A motor vehicle, comprising:
an inductively electrically excited synchronous machine, the synchronous machine including:
a rotor including at least one rotor coil for generating a magnetic rotor field,
a stator on which the rotor is rotatably mounted about an axis of rotation, the stator including at least one stator coil for generating a magnetic stator field,
a rotary transformer including at least one transformer primary coil fixed to the stator and at least one transformer secondary coil arranged fixed to the rotor for supplying the at least one rotor coil with electrical energy,
a machine control which for operating the synchronous machine as a motor and/or as a generator is connected to the at least one stator coil and to the at least one transformer primary coil,
at least one demagnetisation circuit electrically interconnected with the at least one stator coil, the at least one demagnetization circuit including a switching device for activating and deactivating the at least one demagnetisation circuit and at least one consumer of electrical energy and/or at least one store for electrical energy,
wherein the switching device is configured and/or controlled so that during a normal operation of the synchronous machine the switching device deactivates the at least one demagnetisation circuit and that upon a machine fault the switching device activates the at least one demagnetisation circuit.

19. The motor vehicle according to claim 18, wherein the synchronous machine is configured as a drive motor or a traction motor, and/or the synchronous machine is configured to a power of 100 kW to 200 kW.

20. The motor vehicle according to claim 18, wherein:
the machine control includes an inverter for supplying electrical energy to the at least one stator coil, the inverter connected to the at least one stator coil via a first inverter line and a second inverter line for transmitting electrical energy,
the first inverter line is electrically connected to a first coil end of the at least one stator coil, and the second inverter line is electrically connected to a second coil end of the at least one stator coil, and
the at least one demagnetisation circuit for the electrical interconnection with the at least one stator coil includes a circuit line pair with a first circuit line and a second circuit line.
